(19) United States
(12) Patent Application Publication
(10) Pub. No.: US 2014/0110638 A1
(43) Pub. Date: Apr. 24, 2014

(54) CONDUCTIVE FILM, METHOD FOR MANUFACTURING THE SAME, AND TOUCH PANEL

(71) Applicant: Fujifilm Corporation, Tokyo (JP)

(72) Inventors: Nori MIYAGISHIMA, Ashigarakami-gun (JP); Shinichi NAKAHIRA, Ashigarakami-gun (JP); Kenji NAOI, Ashigarakami-gun (JP)

(73) Assignee: Fujifilm Corporation, Tokyo (JP)

(21) Appl. No.: 14/143,983

(22) Filed: Dec. 30, 2013

Related U.S. Application Data
(63) Continuation of application No. PCT/JP2012/066219, filed on Jun. 26, 2012.

(30) Foreign Application Priority Data
Jun. 30, 2011 (JP) 2011-146061

(51) Int. Cl. C09D 5/24; H01B 1/02; H01B 13/00

(52) U.S. Cl. CPC C09D 5/24; H01B 13/0036; H01B 1/02
USPC 252/514; 252/512

(57) ABSTRACT

The method for manufacturing a conductive film includes cleaning a metal nanowire dispersion, which contains metal nanowires with an average short axis length of 150 nm or less as metal particles and a dispersing agent by performing ultrafiltration using an ultrafiltration film, and coating a coating liquid for forming a conductive film, which contains the metal nanowire dispersion after cleaning, onto a support, where the content ({mass of the dispersing agent/(mass of all metal particles+mass of the dispersing agent)}×100) of the dispersing agent in the metal nanowire dispersion after cleaning is 3.2 mass % or more.

### BACKGROUND OF THE INVENTION

1. Field of the Invention

The present invention relates to a conductive film and a method for manufacturing the same, and to a touch panel which has the conductive film.

2. Description of the Related Art

Conductive films are widely used in touch panels, display electrodes, electromagnetic shielding, organic electroluminescent (EL) display electrodes, inorganic EL display electrodes, electronic paper, flexible display electrodes, solar cells, display elements, and various other types of devices, and, in recent years, demand has been growing for conductive films as members in electric and electronic fields.

The material which configures the conductive film is generally ITO; however, in recent years, metal nanowires have been proposed (for example, refer to JP2009-215594A).

Conductive films which include metal nanowires have high transparency, low surface resistivity, and good conductivity. In addition, it is possible to realize the film forming method thereof with a simple method such as coating the metal nanowire dispersion, which is advantageous from the point of view that large scale equipment is not needed.

A dispersing agent is added to the metal nanowire dispersion in order to prevent the aggregation of the metal nanowires and maintain a stable dispersion property. However, the dispersing agent is adsorbed onto the surface of the metal nanowires and inhibits the metal nanowires from forming a network with each other, thereby decreasing the conductivity.

In addition, a method for manufacturing a silver nanowire dispersion has also been proposed which includes a step where cleaning is carried out with a solvent such as water or alcohol and the dispersing agent is removed after a silver nanowire dispersion which is prepared using a polyol method undergoes a centrifugation step and an ultrafiltration step (refer to JP2009-129732A). In these proposals, the conductive film is formed by preparing, coating, and drying the silver nanowire dispersion and it is estimated that it is possible to reduce the contact resistance between the silver nanowires and improve conductivity by reducing the dispersing agent which is adsorbed onto the surface of the silver nanowires.

The present inventors proposed the manufacturing of a transparent conductive film by manufacturing metal nanowires with an aqueous HTAB (hexadecyl trimethyl ammonium bromide) method (refer to JP2010-84173A).

### SUMMARY OF THE INVENTION

In JP2010-84173A, when cleaning is carried out with a solvent such as water or alcohol after the dispersion which includes the metal nanowires undergoes a centrifugation step or an ultrafiltration step, the metal nanowires are aggregated during the cleaning, and there are cases where pimple defects occur with lumps of the metal nanowires as cores after the coating. The pimple defects have the meaning of a phenomenon where lumps of the metal nanowires which are from a micron to a sub-micron order are formed on the transparent conductive film surface.

The present invention has an object of solving the above problems and achieving the following objectives. That is, the present invention has an object of providing a method for manufacturing a conductive film with excellent conductivity and transparency and with few pimple defects where favorable dispersion is possible without the metal nanowires being aggregated during coating, a conductive film which is manufactured using the manufacturing method, and a touch panel which has the conductive film.

In order to solve the above problems, the present inventors found the following as a result of intensive research. That is, the present inventors found that since the method for manufacturing a conductive film of the present invention includes at least a cleaning step of performing ultrafiltration using an ultrafiltration film on a metal nanowire dispersion which contains at least metal nanowires with an average short axis length of 150 nm or less as metal particles and a dispersing agent, and cleaning the metal nanowire dispersion, and in which the content ({mass of the dispersing agent/(mass of the metal particles+mass of the dispersing agent)}×100) of the dispersing agent in the metal nanowire dispersion after the cleaning step is 3.2 mass % or more, favorable dispersion is possible without the metal nanowires being aggregated during coating, and it is possible to manufacture a conductive film where hazing is low, with few pimple defects, and with excellent conductivity and transparency, thereby completing the present invention.

The present invention is based on the findings of the present inventors and the means for solving the problems are as follows.

<1> A method for manufacturing a conductive film including cleaning a metal nanowire dispersion, which contains metal nanowires with an average short axis length of 150 nm or less as metal particles and a dispersing agent, by performing ultrafiltration using an ultrafiltration film, and coating a coating liquid for forming a conductive film, which contains the metal nanowire dispersion after cleaning step, onto a support, where the content ({mass of the dispersing agent/(mass of all metal particles+mass of the dispersing agent)}×100) of the dispersing agent in the metal nanowire dispersion after cleaning is 3.2 mass % or more.

<2> The method for manufacturing a conductive film according to <1>, where the content of the dispersing agent is 3.2 mass % or more and 20 mass % or less.

<3> The method for manufacturing a conductive film according to <1>, where the content of the dispersing agent is 3.2 mass % or more and 5 mass % or less.

<4> The method for manufacturing a conductive film according to any of <1> to <3>, where the metal nanowires are formed by heating an aqueous solution which contains a metallic complex to a temperature which is the boiling point or less of the aqueous solution to reduce the metallic complex.

<5> The method for manufacturing a conductive film according to any of <1> to <4>, where the dispersing agent is at least one selected from a group consisting of polyvinyl pyrrolidone, hexadecyl trimethyl ammonium bromide (HTAB), hexadecyl trimethyl ammonium chloride (HTAC), and stearyl trimethyl ammonium bromide (STAB).

<6> The method for manufacturing a conductive film according to any of <1> to <5>, where the pore diameter of the ultrafiltration film is 1 μm or less.

<7> The method for manufacturing a conductive film according to any of <1> to <6>, wherein a cleaning fluid used during the ultrafiltration is a solution which includes a dispersing agent.

<8> The method for manufacturing a conductive film according to any of <1> to <7>, which does not include a dispersing step of dispersing the metal nanowire in the presence of the dispersing agent using a disperser.

<9> The method for manufacturing a conductive film according to any of <1> to <8>, where the metal nanowires of which the average short axis length is 50 nm or less and the average long axis length is 5 μm or more are included as 50 mass % or more of the metal amount in all the metal particles.

<10> The method for manufacturing a conductive film according to any of <1> to <9>, where the metal nanowires contain silver.

<11> A conductive film which is manufactured using the method for manufacturing a conductive film according to any of <1> to <10>.

<12> A touch panel which has the conductive film according to <11>.

<13> A method for manufacturing a metal nanowire dispersion including a cleaning step of performing ultrafiltration using an ultrafiltration film on a metal nanowire dispersion, which contains metal nanowires with an average short axis length of 150 nm or less as metal particles and a dispersing agent, and cleaning the metal nanowire dispersion, where the content ({mass of the dispersing agent/(mass of all metal particles+mass of the dispersing agent)}×100) of the dispersing agent in the metal nanowire dispersion after the cleaning step is 3.2 mass % or more.

According to the present invention, it is possible to provide a method for manufacturing a conductive film with excellent conductivity and transparency, low hazing, and with few pimple defects, where favorable dispersion is possible without the metal nanowires being aggregated during coating, a conductive film which is manufactured by the method for manufacturing a conductive film, and a touch panel which has the conductive film.

### BRIEF DESCRIPTION OF THE DRAWINGS

FIG. 1 is a schematic cross-sectional diagram which shows an example of a touch panel (surface capacitive type) of the present invention.

FIG. 2 is a schematic cross-sectional diagram which shows another example of the touch panel (surface capacitive type) of the present invention.

FIG. 3 is a schematic cross-sectional diagram which shows an example of the touch panel (projected capacitive type) of the present invention.

FIG. 4 is a schematic cross-sectional diagram which shows an example of the touch panel (resistive film type) of the present invention.

### DESCRIPTION OF THE PREFERRED EMBODIMENTS

(Method For Manufacturing Conductive Film)

A method for manufacturing a conductive film of the present invention includes at least a cleaning step and a coating step, and further includes other steps as necessary.

<Cleaning Step>

The cleaning step is a step of performing ultrafiltration using an ultrafiltration film on a metal nanowire dispersion, which contains at least metal nanowires with an average short axis length of 150 nm or less and a dispersing agent, and cleaning the metal nanowire dispersion.

<<Metal Nanowire Dispersion>>

The metal nanowire dispersion includes at least a metal nanowire and a dispersing agent, preferably further includes a solvent, and further contains other components as necessary.

—Metal Nanowire—

The metal nanowires are metal nanowires of which the average short axis length is 150 nm or less. In the present invention, “wire” has the meaning of a fiber with a solid structure.

—Material—

The material of the metal nanowires is not particularly limited and it is possible to appropriately select the material according to the object, for example, preferably at least one type of metal which is selected from a group which is formed of the fourth period, the fifth period, and the sixth period of the long periodic table (IUPAC1991), more preferably at least one type of metal which is selected from group 2 to group 14, and particularly preferably at least one type of metal which is selected from group 2, group 8, group 9, group 10, group 11, group 12, group 13, and group 14. In addition, these materials are particularly preferably included as the main component.

Examples of the metals include copper, silver, gold, platinum, palladium, nickel, tin, cobalt, rhodium, iridium, iron, ruthenium, osmium, manganese, molybdenum, tungsten, niobium, tantalum, titanium, bismuth, antimony, lead, or alloys thereof. Among these, silver or alloys of silver and other metals are preferable in terms of excellent conductivity.

The other metals in the alloy are not particularly limited and it is possible to appropriately select the other metals according to the object; however, gold, platinum, osmium, palladium, and iridium are preferable. These may be used alone as one type or may be used in a combination of two or more types.

—Shape—

The shape of the metal nanowires is not particularly limited as long as it has a solid structure, and it is possible to appropriately select the shape according to the object, for example, it is possible to take an arbitrary shape such as a cylindrical shape, a rectangular shape, or a columnar shape with a polygon cross-section; however, a cylindrical shape or a cross-sectional shape with a polygon cross-section with rounded corners are preferable in applications where high transparency is required.

It is possible to determine the cross-sectional shape of the metal nanowires by coating a metal nanowire aqueous dispersion onto a substrate and observing the cross-section with a transmission electron microscope (TEM).

—Average Short Axis Length—

The average short axis length (below, may be referred to as the “average short axis diameter” or the “average diameter”) of the metal nanowire is 150 nm or less, preferably 50 nm or less, and more preferably 30 nm or less. When the average short axis length exceeds 150 nm, the hazing rate may increase and the pimple defects are easily generated.

In addition, the lower limit of the average short axis length is not particularly limited, and it is possible to appropriately select the length according to the object; however, 1 nm or more is preferable, and 10 nm or more is more preferable. When the lower limit of the average short axis length is less than 1 nm, the oxidation resistance may be deteriorated, and the durability may be poor.

Accordingly, the average short axis length of the metal nanowire is preferably 1 nm to 150 nm, more preferably 10 nm to 50 nm, and particularly preferably 10 nm to 30 nm.

Here, in the present invention, the average short axis length of the metal nanowires is the average value of the short axis lengths of at least 300 metal nanowires where the short axis lengths are measured by observing the metal nanowires using a transmission electron microscope (TEM).

—Average Long Axis Length—

The average long axis length of the metal nanowires (may be referred to below as the “average length”) is not particularly limited and it is possible to appropriately select the length according to the object; however, 1 μm or more is preferable, 3 μm or more is more preferable, and 5 μm or more is particularly preferable. When the average long axis length is less than 1 μm, it is difficult to form a dense network and it may not be possible to obtain sufficient conductivity.

In addition, the upper limit of the average long axis length is not particularly limited and it is possible to appropriately select the upper limit according to the object; however, since entwining occurs during the metal nanowire manufacturing or aggregations are generated in the manufacturing processes when the length is too long, the average long axis length is preferably 1 mm or less, more preferably 100 μm or less, and even more preferably 30 μm or less.

Accordingly, the average long axis length of the metal nanowires is preferably 1 μm to 100 μm, more preferably 3 μm to 30 μm, and particularly preferably 5 μm to 30 μm.

In the present invention, the average long axis length of the metal nanowires is the average value of the long axis lengths of at least 300 metal nanowires where the long axis lengths are measured by observing the metal nanowires using a transmission electron microscope (TEM).

Here, in a case where the metal nanowires are bent, values, which are calculated from the radiuses and the curvature of circles based on the arcs thus formed, are set as the long axis lengths.

—Aspect Ratio—

The ratio of the average long axis length and the average short axis length of the metal nanowires is defined as the average aspect ratio. The average aspect ratio of the metal nanowires is not particularly limited and it is possible to appropriately select the ratio according to the object; however, 10 to 5,000 is preferable, 30 to 1,000 is more preferable, and 40 to 500 is particularly preferable.

It is possible to measure the aspect ratio using, for example, an electron microscope or the like. In a case where the aspect ratio of the metal nanowires is high, it is possible to perform the measurement by observing the field of view which is adjacent to the electron microscope. In addition, by measuring the long axis lengths and the short axis lengths of the metal nanowires at various different magnifications and obtaining the average values, it is possible to estimate the aspect ratio of the metal nanowires as a whole.

—Suitable Metal Nanowire Ratio—

The content of the metal nanowires in the metal nanowire dispersion is not particularly limited and it is possible to appropriately select the content according to the object; however, the content of the metal nanowires of which the average short axis length is 50 nm or less and the average long axis length is 5 μm or more in all of the metal particles is preferably 50 mass % or more of the metal amount, more preferably 60 mass % or more, and particularly preferably 75 mass % or more. In the present invention, the content of the metal nanowires may be referred to below as the “suitable metal nanowire ratio”.

When the suitable metal nanowire ratio is less than 50 mass %, the conductivity may be decreased, which may be because the conductive materials which impart conductivity are decreased. In addition, at the same time, the durability may be decreased, which may be because voltage concentrations occur since it is not possible to form dense networks. In addition, particles with a shape other than that of a metal nanowire are not preferable due to not greatly imparting conductivity and having absorption. In particular, in a case where the material is metal, the transparency may be deteriorated in a case where the metal has a shape such as a sphere where the plasmon absorption is strong.

Here, regarding the suitable metal nanowire ratio, for example, in a case where the metal nanowire is a silver metal nanowire, it is possible to determine the suitable metal nanowire ratio by separating the silver nanowire and other particles by filtering the silver metal nanowire dispersion and respectively measuring the Ag amount which remains on filter paper and the Ag amount which passes through the filter paper using an ICP emission spectrometer. It is confirmed that the metal nanowires have an average short axis length of 50 nm or less and an average long axis length of 5 μm or more by observing the metal nanowires which remain on the filter paper with a transmission electron microscope (TEM), observing the short axis lengths of the 300 pieces of metal nanowire, and determining their distribution. Here, the longest axis of the particles other than the metal nanowires of which the average short axis length is 50 nm or less and the average long axis length is 5 μm or more is measured with a TEM image, and it is preferable to use filter paper where the diameter is twice or more the measured longest axis and equal to or less than the shortest length of the long axis of the metal nanowires.

—Variation Coefficient—

The variation coefficient of the short axis length of the metal nanowires is not particularly limited and it is possible to appropriately set the coefficient according to the object; however, 40% or less is preferable, 35% or less is more preferable, and 30% or less is particularly preferable. When the variation coefficient exceeds 40%, the durability may be deteriorated, which may be because the voltage is concentrated in the wires where the short axis length is short.

It is possible to determine the variation coefficient of the short axis length of the metal nanowires, for example, by measuring the diameter of 300 pieces of nanowires from the transmission electron microscope (TEM) image and calculating the standard deviation and the average values thereof.

—Dispersing Agent—

The dispersing agent is not particularly limited as long as it is possible to disperse the metal nanowires and it is possible to appropriately select the dispersing agent according to the object; however, a surfactant and/or a polymer which includes at least one of nitrogen, sulfur, and oxygen is preferable. These may be used alone as one type or may be used in a combination of two or more types.

Specific examples of the dispersing agent include ionic surfactants such as quaternary alkyl ammonium salts, amino group-containing compounds, thiol group-containing compounds, sulfide group-containing compounds, amino acids or derivatives thereof, peptide compounds, polysaccharides, natural polymers derived from polysaccharides, synthetic polymers, polymers such as gels derived from these, and the like.

Examples of the quaternary alkyl ammonium salts include hexadecyl trimethyl ammonium bromide (HTAB), hexadecyl trimethyl ammonium chloride (HTAC), hexadecyl trimethyl ammonium hydroxide, stearyl trimethyl ammonium bromide (STAB), stearyl trimethyl ammonium chloride, stearyl trimethyl ammonium hydroxide, tetradecyl trimethyl ammonium bromide, tetradecyl trimethyl ammonium chloride, dilauryl dimethyl ammonium bromide, dilauryl dimethyl ammonium chloride, and the like. Among these, hexadecyl trimethyl ammonium bromide (HTAB), hexadecyl trimethyl ammonium chloride (HTAC), and stearyl trimethyl ammonium bromide (STAB) are particularly preferable.

The polymers are not particularly limited as long as elements such as nitrogen, sulfur, and oxygen are included and the molecular weight is 1,000 or more, and it is possible to appropriately select the polymers according to the object. Examples thereof include gelatin, polyvinyl alcohol, methylcellulose, hydroxy propyl cellulose, polyalkylene amine, partial alkyl esters of polyacrylic acid, polyvinyl pyrrolidone (PVP), polyvinyl pyrrolidone copolymers, and the like.

Among these, polyvinyl pyrrolidone, amino group-containing compounds, hexadecyl trimethyl ammonium bromide (HTAB), hexadecyl trimethyl ammonium chloride (HTAC), and stearyl trimethyl ammonium bromide (STAB) are particularly preferable as the dispersing agent.

—Solvent—

The solvent is not particularly limited and it is possible to appropriately select the solvent according to the object; however, a hydrophilic solvent is preferable.

The hydrophilic solvent is not particularly limited and it is possible to appropriately select the hydrophilic solvent according to the object with examples thereof including water; alcohol solvents such as methanol, ethanol, propanol, isopropanol, butanol, and ethylene glycol; ether solvents such as dioxane, and tetrahydrofuran; ketone solvents such as acetone; polyol solvents such as ethylene glycol, propylene glycol, and the like. These may be used alone as one type or may be used in a combination of two or more types.

Among these, water is particularly preferable, and in a case where a solvent other than water is contained, a solvent which is miscible with water is preferably used in a ratio of 80 vol % or less with respect to the water.

—Other Components—

The other components are not particularly limited and it is possible to appropriately select the other components according to the object; however, a corrosion inhibiting agent is preferably included, and examples of other components include various types of additives such as surfactants other than the dispersing agent, polymerizable compounds, antioxidants, sulfide inhibiting agents, viscosity adjusting agents, and preserving agents. These may be used alone as one type or may be used in a combination of two or more types.

The corrosion inhibiting agent is not particularly limited and it is possible to appropriately select the corrosion inhibiting agent according to the object; however, an azole-based compound is preferable.

The azole compound is not particularly limited and it is possible to appropriately select the azole compound according to the object, with examples thereof including at least one type which is selected from benzotriazole, tolyltriazole, mercaptobenzothiazole, mercaptobenzotriazole, mercaptobenzotetrazole, (2-benzothiazolylthio) acetic acid, 3-(2-benzothiazolylthio) propionic acid, and alkali metal salts, ammonium salts, and amine salt thereof. These may be used alone as one type or may be used in a combination of two or more types.

It is possible to exhibit a superior rust prevention effect as a result of the metal nanowire dispersion containing the corrosion inhibiting agent. The corrosion inhibiting agent may be directly added to the metal nanowire dispersion, may be added in a state of being dissolved in a suitable solvent or a powder state, or may be applied by forming the nanoparticle-containing layer or the conductive film and then immersing this in a corrosion inhibiting agent bath.

—Manufacturing Method—

The method of preparing the metal nanowire is not particularly limited and it is possible to appropriately select the method according to the object; however, a method where the metal nanowires are formed by heating and reducing an aqueous solution which contains a metallic complex to a temperature which is the boiling point or less of the aqueous solution is preferable, and it is even more preferable to include the dispersing agent and a halogen compound in the aqueous solution which contains the metallic complex.

In addition, as the method of preparing the metal nanowire, for example, it is possible to use methods which are described in JP2009-215594A, JP2009-242880A, JP2009-299162A, JP2010-84173A, JP2010-86714A, or the like.

The metallic complex is not particularly limited and it is possible to appropriately select the metallic complex according to the object; however, a silver complex is particularly preferable. Examples of the ligand of the silver complex include CN—, SCN—, SO₃²—, thiourea, and ammonia, and the like. With regard to these, it is possible to refer to the description in “The Theory of the Photographic Process 4th Edition” by T. H. James and Macmillan Publishing. Among these, a silver ammonia complex is particularly preferable.

The stage of adding the metallic complex is not particularly limited and it is possible to appropriately select the step according to the object; however, the addition of the metallic complex is preferably performed after the addition of the dispersing agent. By performing the addition in this order, there is an effect of increasing the ratio of the metal nanowires with suitable diameters and long axis lengths, which may be because it is possible to form the wire cores with high probability.

The halogen compounds are not particularly limited and it is possible to appropriately select the compounds according to the object; however, compounds containing bromine, chlorine, and iodine are preferable, and for example, alkali halides such as sodium bromide, sodium chloride, sodium iodide, potassium iodide, potassium bromide, potassium chloride, and potassium iodide or compounds which can be used in combination with the dispersing agent are more preferable.

Depending on the type of the halogen compound, the compound may also function as a dispersing agent and it is possible for the compound to be preferably used in the same manner.

Silver halide particles may be used as a replacement for the halogen compound and the halogen compound and the silver halide particles may be used in combination.

The dispersing agent and the halogen compounds may be the same material and may be used in combination. Examples of the compounds where the dispersing agent and the halogen compound are used in combination include the HTAB (hexadecyl trimethyl ammonium bromide) which includes an amino group and bromide ions, the HTAC (hexadecyl trimethyl ammonium chloride) which includes an amino group and chloride ions, dodecyl trimethyl ammonium bromide, dodecyl trimethyl ammonium chloride, stearyl trimethyl ammonium bromide, stearyl trimethyl ammonium chloride, decyl trimethyl ammonium bromide, decyl trimethyl ammonium chloride, dimethyl stearyl ammonium bromide, dimethyl distearyl ammonium chloride, dilauryl dimethyl ammonium bromide, dilauryl dimethyl ammonium chloride, dimethyl dipalmityl ammonium bromide, dimethyl dipalmityl ammonium chloride, and the like, which include an amino group and a bromide ion or a chloride ion.

The stage of adding the dispersing agent and the halogen compound is not particularly limited and it is possible to appropriately select the step according to the object. For example, the dispersing agent and the halogen compound may be added to the solvent in advance and the metallic complex which is the core of the metal nanowire may be added in the presence of the dispersing agent and the halogen compound, or the dispersing agent and the halogen compound may be added after forming metal particles in the solvent in order to control the dispersion state.

When the addition of the dispersing agent and the halogen compound is divided into two stages or more, there is a need to change the amounts thereof according to the lengths of the required metal nanowires. It is considered that this is because the necessary amounts of the dispersing agent and the halogen compound are increased or decreased since the surface area of the metal nanowires is increased or decreased according to the length of metal nanowires.

In addition, depending on the type of dispersing agent to be used, it is also possible to change the shape of the obtained metal nanowires.

The heating temperature during heating is not particularly limited and it is possible to appropriately select the temperature according to the object; however, a temperature which is the boiling point or less of the aqueous solution which contains the metallic complex is preferable. As the temperature, 150° C. or less is preferable, 20° C. to 130° C. is more preferable, 30° C. to 100° C. is even more preferable, and 40° C. to 90° C. is particularly preferable. When the heating temperature is less than 20° C., the metal nanowires may be easily entwined and the dispersion stability may be deteriorated. This is because as the heating temperature is lowered, the core forming probability decreases, and the metal nanowires become too long. In addition, when the heating temperature exceeds 150° C., the angle of the cross-section of the metal nanowire may be steeper, and the transmittance may be lower in the coating film evaluation.

As necessary, the temperature may be changed as appropriate in the forming process of the metal nanowire. By changing the temperature in the forming process of the metal nanowires, it is easy to control the forming of the cores of the metal nanowires and it is easy to suppress the cores from being re-generated. In addition, it is possible to promote selective growth and to improve the monodispersity.

It is preferable to add a reducing agent during the heating. The stage of adding the reducing agent may be before or after the addition of the dispersing agent.

The reducing agent is not particularly limited and it is possible to appropriately select the agent from among those which are commonly used, with examples thereof including metal borohydride salt, aluminum hydride salt, alkanolamine, aliphatic amines, heterocyclic amines, aromatic amines, aralkyl amines, alcohols, organic acids, reducing sugars, sugar alcohols, sodium sulfite, hydrazine compounds, dextrin, hydroquinone, hydroxylamine, citric acid or salts thereof, succinic acid or salts thereof, ascorbic acid or salts thereof, ethylene glycol, glutathione, and the like.

Examples of the metal borohydride salt include sodium borohydride, potassium borohydride, and the like.

Examples of the aluminum hydride salt include lithium aluminum hydride, potassium aluminum hydride, cesium aluminum hydride, beryllium aluminum hydride, magnesium aluminum hydride, calcium aluminum hydride, and the like.

Examples of the alkanolamines include diethylamino ethanol, ethanolamine, propanol amine, triethanolamine, dimethyl amino propanol, and the like.

Examples of the aliphatic amines include propylamine, butylamine, dipropylene amine, ethylenediamine, triethylene pentamine, and the like.

Examples of the heterocyclic amines include piperidine, pyrrolidine, N-methyl pyrrolidine, morpholine, and the like.

Examples of the aromatic amines include aniline, N-methyl aniline, toluidine, anisidine, phenetidine and the like.

Examples of the aralkyl amines include benzylamine, xylene diamine, N-methyl benzyl amine, and the like.

Examples of the alcohols include methanol, ethanol, 2-propanol, and the like.

Examples of the organic acids include citric acid, malic acid, tartaric acid, succinic acid, ascorbic acid, salts thereof, and the like.

Examples of the reducing sugars include glucose, galactose, mannose, fructose, sucrose, maltose, raffinose, stachyose, and the like.

Examples of the sugar alcohols include sorbitol and the like.

Among these, reducing sugars and sugar alcohols are preferable, and glucose is particularly preferable.

According to the type of the reducing agent, there are cases where the reducing agent exhibits a function as the dispersing agent or a solvent and it is possible for the reducing agent to be preferably used in the same manner.

<<Ultrafiltration>>

In the present invention, the ultrafiltration has the meaning of a method of filtration while the metal nanowire dispersion flows parallel with respect to the liquid flow direction (the thickness direction of the ultrafiltration film) of the ultrafiltration film.

In the cleaning step, the metal nanowires remain on the ultrafiltration film, and the dispersing agent passes through the ultrafiltration film. Therefore, it is possible to appropriately adjust the content of the dispersing agent to the desired amount.

The pore diameter of the ultrafiltration film is not particularly limited and it is possible to appropriately select the diameter according to the content or the like of the dispersing agent which is the object after the cleaning step; however, 4 nm or more is preferable since it is not possible for the dispersing agent to pass through when the diameter is too small.

The upper limit of the pore size is not particularly limited and it is possible to appropriately select the upper limit according to the object; however, since the metal nanowires easily clog the filter when the pore diameter is too large, the upper limit of the pore diameter is preferably 1 μm or less, more preferably 0.5 μm or less, even more preferably 0.25 μm or less.

It is possible to use a commercially available product as the ultrafiltration film and examples of the commercially available products include Ultrafiltration Module USP-043 (manufactured by Asahi Kasei Co., Ltd., pore diameter 0.1 μm), PSP-003 (manufactured by Asahi Kasei Co., Ltd., pore diameter 0.1 μm), UMP-053 (manufactured by Asahi Kasei Co., Ltd., pore diameter 0.2 μm), PMP-003 (manufactured by Asahi Kasei Co., Ltd., pore diameter 0.25 μm), ULP-043 (manufactured by Asahi Kasei Co., Ltd., pore diameter 0.45 μm) and the like. It is possible to appropriately select these according to the content or the like of the dispersing agent which is the object after the cleaning step.

In the cleaning step, examples of the method of performing ultrafiltration include a method where a pencil type modular table top filtration unit PX-02001 manufactured by Asahi Kasei Co., Ltd., or the like is used. Specifically, the method is a method where cleaning is performed by adding a cleaning fluid to return a sample to the initial concentration after rotating the sample inside the ultrafiltration unit and increasing the concentration of the sample by discharging filtrate from a drainage outlet.

The cleaning step may be performed once or may be repeated as long as the content ({mass of the dispersing agent/(mass of all metal particles+mass of the dispersing agent)}×100) of the dispersing agent in the metal nanowire dispersion after the cleaning step is 3.2 mass % or more. According to the number of times of the cleaning step, it is possible to appropriately adjust the content of the dispersing agent to the desired amount.

Here, the “mass of the dispersing agent” indicates the mass of the dispersing agent in the metal nanowire dispersion without passing through the ultrafiltration film after the cleaning step, and the “mass of all metal particles” indicates the mass of all the metal particles in the metal nanowire dispersion without passing through the ultrafiltration film after the cleaning step.

In addition, the content (the content of the dispersing agent in the metal nanowire dispersion without passing through the ultrafiltration film) of the dispersing agent in the metal nanowire dispersion after the cleaning step needs to be 3.2 mass % or more, preferably 3.2 mass % or more and 20 mass % or less, more preferably 3.2 mass % or more and 10 mass % or less, and even more preferably 3.2 mass % or more and 5 mass % or less. When the content of the dispersing agent is less than 3.2 mass %, it may not be possible to obtain sufficient conductivity and transparency, the hazing may be high, and pimple defects may occur.

It is possible for the content of the dispersing agent to be measured using a differential thermal gravimetric apparatus (TG/DTA200 manufactured by Seiko Instruments Inc.).

<<Cleaning Solution>>

A cleaning solution is not particularly limited as long as it is possible to adjust the content of the dispersing agent in the metal nanowire dispersion to 3.2 mass % or more, and the cleaning solution may appropriately include the dispersing agent according to the content of the dispersing agent which is the object after the cleaning step.

The number of times of cleaning using the cleaning solution in the cleaning step is not particularly limited as long as the content of the dispersing agent in the metal nanowire dispersion is 3.2 mass % or more, it is possible to appropriately select the number of times according to the content or the like of the dispersing agent which is the object after the cleaning step, and the cleaning step may be performed once or repeated a plurality of times. In addition, when the step is repeated, the repeating may be performed in an appropriate combination with the ultrafiltration step.

In addition, after cleaning with the cleaning solution which includes the dispersing agent, cleaning may be performed with a solvent.

The cleaning solution includes at least a solvent, preferably includes a dispersing agent, and further includes other components as necessary.

—Dispersing Agent—

The dispersing agent is not particularly limited as long as it is possible to disperse the metal nanowires and it is possible to appropriately select the dispersing agent according to the object; however, the same dispersing agent as the dispersing agent in the metal nanowire dispersion is preferable.

The content of the dispersing agent in the cleaning solution is not particularly limited and it is possible to appropriately select the content according to the object; however, 20 mass % or less with respect to the metal nanowires is preferable, and 2 mass % to 10 mass % is more preferable. When the content exceeds 20 mass %, the contact between the wires may be inhibited when the coating film is set, and the conductivity may be decreased.

—Solvent—

The solvent is not particularly limited and it is possible to appropriately select the solvent according to the object; however, the same solvent as the solvent in the metal nanowire dispersion is preferable.

The amount of the cleaning solution to be added and the number of times the solution is added are not particularly limited and it is possible to appropriately select these according to the object.

The cleaning magnification is preferably 10 times or more to 100,000,000 times or less, more preferably 100 times or more to 1,000,000 times or less, and even more preferably 1,000 times or more to 100,000 times or less.

Here, it is possible to calculate the cleaning magnification with the following formulas.

Wₙ=(Vₙ₋₁+Dₙ)/Vₙ

W=W₁×W₂× . . . ×Wₙ

Here,

W: cleaning magnification

Wₙ: cleaning magnification before and after nth cleaning step

Vₙ: metal nanowire dispersion amount after nth cleaning step

Dₙ: added amount of cleaning solution added during nth cleaning step

Here, the cleaning step may be combined with other cleaning methods using dialysis, gel filtration, decantation, centrifugation, or the like in addition to ultrafiltration as long as the content of the dispersing agent after the cleaning step is 3.2 mass % or more.

Examples of cleaning using centrifugation include, for example, a method or the like where the metal nanowire dispersion is centrifuged, a part of the metal nanowires and the dispersing agent are precipitated, the cleaning solution is added to and suspended in the precipitation, and centrifuging is carried out again. The centrifuging may be carried out once or a plurality of times.

The cleaning step is preferable from the point of view that combination with a desalting process is possible in addition to the content of the dispersing agent being 3.2 mass % or more.

In addition, since the surface resistance may be decreased, the coating film which is obtained by coating the metal nanowire dispersion may be immersed in a solvent where the dispersing agent is dissolved.

<Coating Step>

The coating step is a step of coating liquid for forming a conductive film which contains the metal nanowire dispersion after the cleaning step onto a support.

The coating method of the coating liquid for forming a conductive film is not particularly limited and it is possible to appropriately select the method according to the object, with examples including a coating method, a printing method, an ink-jet method, or the like.

Examples of the coating method include a roll coating method, a bar coating method, a dip coating method, a spin coating method, a casting method, a die coating method, a blade coating method, a bar coating method, a gravure coating method, a curtain coating method, a spray coating method, a doctor coating method, and the like.

Examples of the printing method include a letterpress (type-printing) printing method, a stencil (screen) printing method, a lithographic (offset) printing method, an intaglio (gravure) printing method, and the like.

<Other Steps>

The other steps are not particularly limited and it is possible to appropriately select the other steps according to the object, with examples including a step of immersing the conductive film in a corrosion inhibiting agent bath, a step of performing a patterning process, and the like.

Here, the method for manufacturing the conductive film preferably does not include the dispersion step of dispersing the metal nanowire using a disperser in the presence of the dispersing agent after the cleaning step. According to the method for manufacturing a conductive film of the present invention, it is possible to obtain a conductive film where the metal nanowires are distributed uniformly even when such a dispersing step is not included, and there are advantages in that the conductive film has excellent conductivity and transparency, low hazing, and few pimple defects, without peeling.

<Conductive Film>

The conductive film of the present invention is a conductive film which is manufactured by the method for manufacturing a conductive film of the present invention.

The thickness of the conductive film is not particularly limited and it is possible to appropriately select the thickness according to the object; however, the average thickness is preferably 0.01 μm to 0.3 more preferably 0.01 μm to 0.15 μm, and particularly preferably 0.01 μm to 0.08 μm. When the average thickness of the conductive layer is less than 0.01 μm, the in-plane distribution of the conductivity may become uneven and when the average thickness exceeds 0.3 μm, the transmittance may be lowered, and transparency may be impaired.

Here, it is possible to measure the average thickness of the conductive film, for example, by taking out a cross-section of the conductive film using microtome cutting and then performing observation using a scanning electron microscope (SEM) or by embedding the conductive film in epoxy resin and then observing a section prepared with a microtome with a transmission electron microscope (TEM).

Here, the average thickness has the meaning of the average value of thicknesses which are measured at 10 or more arbitrary places in the conductive film.

The content of the metal nanowires in the conductive film is not particularly limited and it is possible to appropriately select the content according to the object; however, 0.0001 g/m² to 1 g/m² is preferable, 0.001 g/m² to 0.5 g/m² is more preferable, and 0.01 g/m² to 0.1 g/m² is particularly preferable.

When the content of the metal nanowires is less than 0.0001 g/m², the conductivity may be decreased since the conductive materials which impart conductivity are decreased, and at the same time, voltage concentrations may be generated since it is not possible to form dense networks, whereby the durability may decrease and the surface resistance may be increased. Furthermore, in a case where components which do not greatly impart conductivity are included in addition to the metal nanowires, the components may have absorption, which is not preferable. In particular, in a case where the components other than the metal nanowires are metal and the metal has a shape with strong plasmon absorption such as a sphere, the transparency may deteriorate.

In addition, when the content of the metal nanowires exceeds 1 g/m², the transmittance may be reduced.

It is possible for the content of the metal nanowires in the conductive layer to be measured, for example, with a fluorescent X-ray analysis apparatus (ICP emission spectrometer) or the like.

The content of the dispersing agent in the conductive film is 3.2 mass % or more with respect to the metal nanowire dispersion, preferably 3.2 mass % to 50 mass %, more preferably 3.2 mass % to 20 mass %, and particularly preferably 3.2 mass % to 5 mass %. When the content of the dispersing agent is less than 3.2 mass %, pimple defects may occur, and when the content exceeds 50 mass %, the contact between the metal nanowires is inhibited and the conductivity may be deteriorated.

<<Surface Resistance>>

The surface resistance of the conductive film is not particularly limited and it is possible to appropriately select the surface resistance according to the object; however, less than 1,000 Ω/sq is preferable, less than 500 Ω/sq is more preferable, and less than 100 Ω/sq is particularly preferable. When the surface resistance is 1,000 Ω/sq or more, there are problems such as that breakages occur easily due to Joule heat which is generated during the passage of electric current, drops in the voltage may occur between the upstream and downstream of the wiring, and the area is limited when used as an electrode material or the like.

A low surface resistance is not a problem in itself; however, when the resistance is less than 10 Ω/sq, it may become difficult to obtain a conductive material which has high light transmittance.

For example, it is possible for the surface resistance value to be measured using a surface resistance meter (Loresta-GP MCP-T600, manufactured by Mitsubishi Chemical Corporation).

Here, a lower surface resistance value means a higher conductivity.

<<Transmittance>>

The transmittance of the conductive film is not particularly limited and it is possible to appropriately select the transmittance according to the object; however, 75% or more is preferable, 80% or more is more preferable, and 90% or more is particularly preferable. When the transmittance is less than 75%, there are problems such as that conductive patterns are noticeable when used in an image display medium such as a touch panel, that the quality of the images may be impaired, and that there may be a need to increase the electric power consumption in order to compensate for a reduction in the brightness.

For example, it is possible for the transmittance to be measured using an integrating sphere light transmittance measuring apparatus (Haze-Gard Plus, manufactured by Gardner Co., Ltd.).

<<Haze>>

The haze of the conductive film is not particularly limited and it is possible to appropriately select the haze according to the object; however, less than 3% is preferable, less than 2% is more preferable, and 1.5% or less is particularly preferable. When the haze is 3% or more, transparency is lost and the visibility deteriorates when being used in touch panels or the like.

For example, it is possible for the haze to be measured using an integrating sphere light transmittance measuring apparatus (Haze-Gard Plus, manufactured by Gardner Co., Ltd.).

<<Pimple Defects>>

The number of pimple defects of the metal nanowires in the conductive film is not particularly limited and it is possible to appropriately select the number according to the object; however, the number of pimple defects of the metal nanowires in 5 cm square of the conductive film is preferably 10 or less, more preferably 5 or less, and particularly preferably 2 or less. When the number of pimple defects exceeds 10, it may not possible to obtain sufficient conductivity or use may no longer be possible due to the visibility of the pimple defects when used in a touch panel or the like.

For example, it is possible for the number of pimple defects to be measured by observation with an optical microscope. Here, at this time, it is preferable to observe the vicinity of the central portion of the conductive film.

Since the conductive film of the present invention which is manufactured by the method for manufacturing a conductive film of the present invention has low hazing, few pimple defects, and excellent conductivity and transparency, where favorable dispersion is possible without the metal nanowires being aggregated during coating, for example, in addition to the touch panel of the present invention described below, the conductive film may be widely used in display electrodes, electromagnetic shielding, organic or inorganic El display electrodes, E-paper, flexible display electrodes, integrated solar cells, display elements, and various other types of device.

(Touch Panel)

The touch panel of the present invention has at least the conductive film of the present invention and further has other members as necessary.

<Substrate>

The shape, structure, size, and the like of the substrate are not particularly limited and it is possible to appropriately select these according to the object, with examples of the shape including a film shape, a sheet shape, and the like. Examples of the structure include a single-layer structure, a laminated structure, and the like. It is possible to appropriately select the size according to the object or the like.

The substrate is not particularly limited and it is possible to appropriately select the substrate according to the object, with examples including a transparent glass substrate, a synthetic resin sheet (film), a metal substrate, a ceramic plate, a semiconductor substrate which has a photoelectric conversion element, or the like. As desired, it is possible to perform pre-treatments on the substrate, such as chemical treatments such as with a silane coupling agent, plasma treatments, ion plating, sputtering, gas phase reaction methods, vacuum deposition, and the like.

The transparent glass substrate, the synthetic resin sheet, and the metal substrate are not particularly limited and it is possible to appropriately select these according to the object, with examples including the same substrates as for the conductive film.

The type of the touch panel is not particularly limited and it is possible to appropriately select the type according to the object, with examples including a resistive touch panel, a surface capacitive touch panel, a projected capacitive touch panel, an electromagnetic induction type touch panel, an ultrasonic surface acoustic wave touch panel, an infrared scanning type touch panel and the like.

Here, in the present invention, the touch panel includes so-called touch sensors and touch pads.

The layer configuration of the touch panel sensor electrode section in the touch panel is not particularly limited and it is possible to appropriately select the configuration according to the object; however, any of a bonding configuration where two layers of conductive films are bonded, a configuration where the conductive films are provided on both sides of one substrate, a single sided jumper or through hole configuration, or a single sided laminated configuration are preferable.

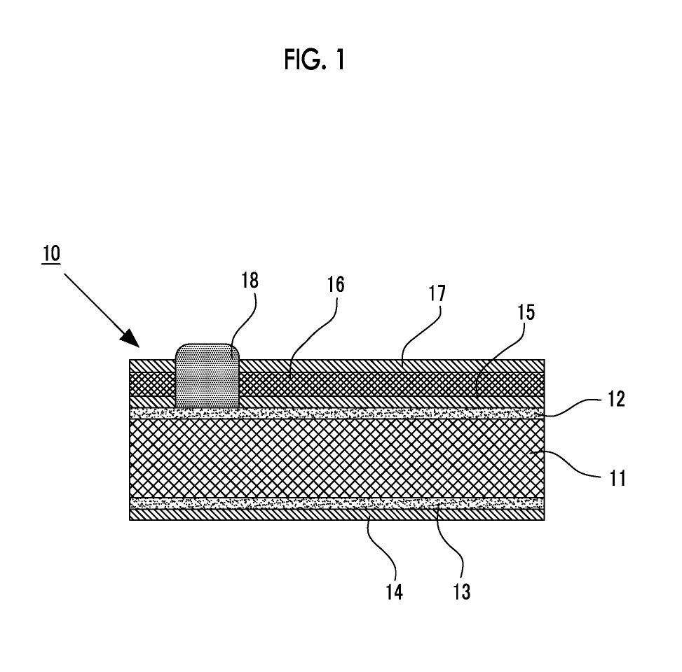

Description will be given of an example of the surface capacitive touch panel with reference to FIG. 1; however, the touch panel of the present invention is not limited thereto.

In FIG. 1, in a touch panel 10, a conductive film 12 is distributed so as to uniformly cover the surface of a transparent substrate 11 and an electrode terminal 18 for electrical connection with an external detection circuit which is not shown in the diagram is formed on the conductive film 12 of an end section of the transparent substrate 11.

Here, in FIG. 1, 13 indicates a conductive film which is a shield electrode, 14 and 17 indicate a protective film, 15 indicates an intermediate protective film, and 16 indicates a glare prevention film.

When an arbitrary point on the conductive film 12 is touched with a finger or the like, the conductive film 12 is grounded via the human body at the point of touch and generates a change in the resistance value between each of the electrode terminals 18 and the ground line. The coordinates of the touched point are specified by detecting the change in the resistance value using an external detection circuit.

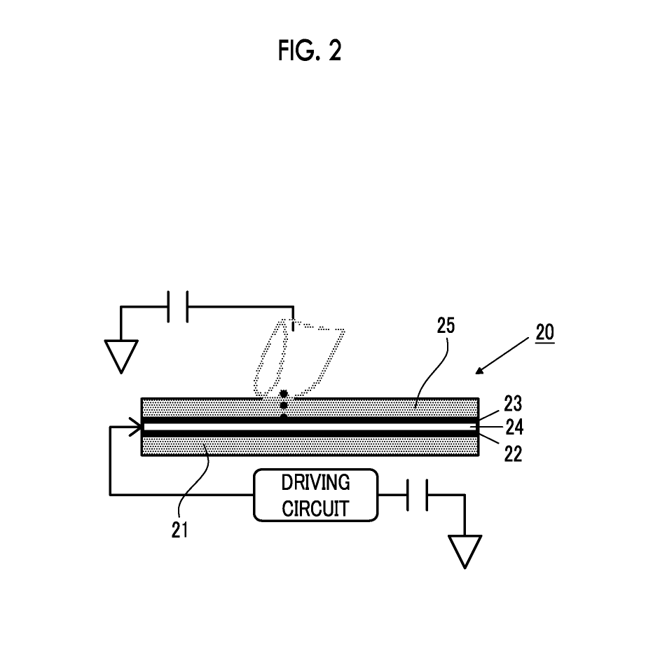

Description will be given of another example of a surface capacitive touch panel with reference to FIG. 2.

In FIG. 2, the touch panel 20 is formed of a conductive film 22 and conductive film 23 which are distributed so as to cover the surface of a transparent substrate 21, an insulating layer 24 which insulates the conductive film 22 and the conductive film 23, and an insulating cover layer 25 where capacitance is generated between the contact object such as a finger and the conductive film 22 or the conductive film 23, and performs positional detection with respect to the contact object such as a finger. According to the structure, it is possible to form the conductive film 22 and the conductive film 23 integrally, and furthermore, the insulating layer 24 or the insulating cover layer 25 may be formed as an air layer.

When the insulating cover layer 25 is touched with a finger or the like, a change is generated in the value of the capacitance between the finger or the like and the conductive film 22 or the conductive film 23. The coordinates of the touched point are specified by detecting the change in the capacitance value using an external detection circuit.

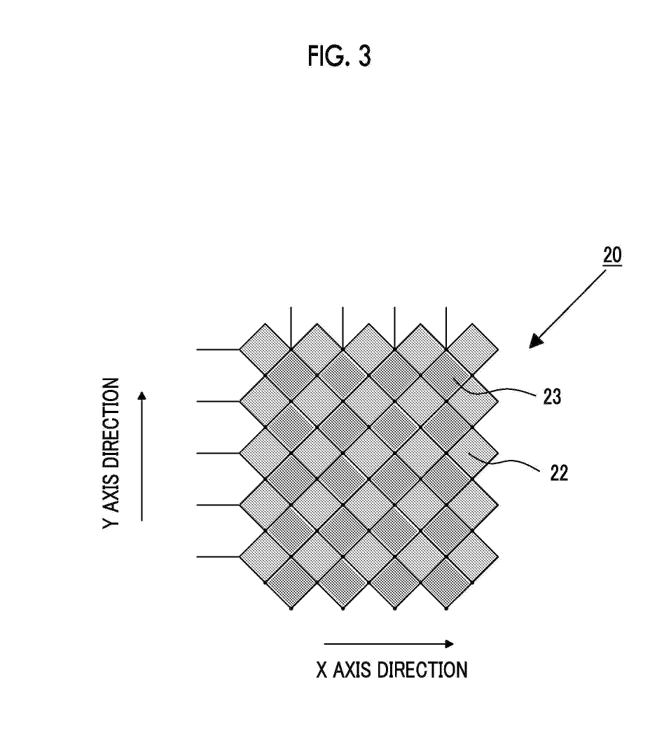

Description will be given of an example of the projected capacitive touch panel with reference to FIG. 3; however, the touch panel of the present invention is not limited thereto.

FIG. 3 is a diagram which schematically illustrates the touch panel 20 as the projected capacitive touch panel through an arrangement where the conductive film 22 and the conductive film 23 are viewed as a horizontal plane.

In the touch panel 20, a plurality of the conductive films 22 which are able to detect the position in the X axis direction and a plurality of the conductive films 23 in the Y axis direction are distributed so as to be able to connect with an external terminal. It is possible for contact information to be input at a number of points by the conductive film 22 and the conductive film 23 coming into contact with the contact object such as a fingertip at a plurality of points.

When an arbitrary point on the touch panel 20 is touched with a finger or the like, the coordinates in the X axis direction and the Y axis direction are specified with good positional precision.

Here, as other structures of the transparent substrate, the protective layer, and the like, it is possible to appropriately select and use the structure of the surface capacitive touch panel. In addition, an example of a pattern of the conductive films has been given using a plurality of the conductive films 22 and a plurality of the conductive films 23 in the touch panel 20; however, the shape, the arrangement, and the like are not limited thereto.

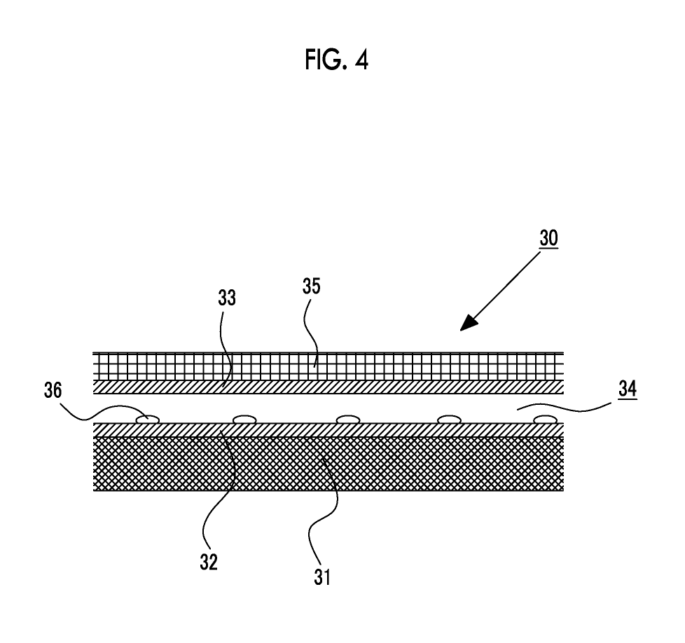

Description will be given of an example of the resistive touch panel with reference to FIG. 4; however, the touch panel of the present invention is not limited thereto.

In FIG. 4, the touch panel 30 has a configuration in which a transparent substrate 31 where a conductive film 32 is distributed, a plurality of spacers 36 which are distributed on the conductive film 32, a conductive film 33 which is able to contact the conductive film 32 via an air layer 34, and a transparent film 35 which is distributed on the conductive film 33 are supported.

When the touch panel 30 is touched from the transparent film 35 side, the transparent film 35 is pressed down and the pressed conductive film 32 and the conductive film 33 come into contact, and the coordinates of the touched point are specified by detecting the change in the potential at this position using an external detection circuit which is not shown in the diagram.

### EXAMPLES

Although specific description will be given of the present invention using the following examples of the present invention, the present invention is not limited to these examples.

<Measurement Method>

In the following preparation examples, the average short axis length (the average diameter) of the silver nanowires, the average long axis length, the variation coefficient of the short axis lengths (the diameters) of the silver nanowires, the suitable metal wire ratio, and the content of the dispersing agent are measured as follows.

<<Average Short Axis Length (Average Diameter) and Average Long Axis Length of Silver Nanowires>>

The average short axis length (the average diameter) and the average long axis length of the silver nanowires were determined from the average values after observing the short axis lengths or the long axis lengths of 300 pieces of silver nanowire using a transmission electron microscope (TEM; manufactured by Jeol Ltd., JEM-2000FX).

<<Variation Coefficient of Short Axis Lengths (Diameters) of Silver Nanowires>>

The variation coefficient was determined by calculating the standard deviation and the average values after observing the short axis lengths of 300 pieces of silver nanowire using a transmission electron microscope (TEM; manufactured by Jeol Ltd., JEM-2000FX).

<<Suitable Metal Wire Ratio>>

The silver nanowires and particles other than the silver nanowires were separated by filtering each of the silver nanowire (aqueous) dispersions, the amount of Ag which remained on the filter paper and the amount of Ag which passed through the filter paper were each measured using an ICP emission spectrometer (manufactured by Shimadzu Corporation, ICPS-8000), and the metal amount (mass %) of the silver nanowires (suitable wires) where the short axis length (the average diameter) was 50 nm or less and the long axis length was 5 μm or more in all of the metal particles was determined.

Here, the separation of the suitable silver wires when determining the suitable metal wire ratio was performed using a membrane filter (manufactured by Millipore Corp., FALP02500, pore diameter 1.0 μm).

<<Content of Dispersing Agent>>

The content of the dispersing agent after the cleaning step was measured using a differential thermal weight measuring apparatus (manufactured by Seiko Instruments, TG/DTA200) and calculated using the following formula (I).

Content ratio of dispersing agent(mass %)={mass of dispersing agent/(mass of all metal particles+mass of dispersing agent)}×100 Formula (I)

The procedure for measuring the content ratio of the dispersing agent was set as follows.

1. A predetermined amount of the dispersion was weighed into a glass petri dish and solidified for 30 minutes at 120° C. on a hot plate.

2. A predetermined amount of the solid obtained in 1 was broken off from the glass petri dish and weighed, set in a TG/DTA apparatus, and the weight change due to heating was measured.

Here, the heating was carried out with the temperature patterns of the following steps a to d under a nitrogen atmosphere.

Step a: heating from room temperature to 80° C. at a rate of 10° C./min

Step b: maintenance at 80° C. for 20 minutes

Step c: heating from 80° C. to 550° C. at a rate of 10° C./min

Step d: maintenance at 550° C. for 5 minutes

3. In the measurement described above, the weight after completion of step b is defined as the total mass of all of the metal particles and the dispersing agent, the weight after the completion of step d is defined as the mass of all the metal particles, and (the mass after completion of step b−the mass after the completion of step d) is defined as the mass of the dispersing agent.

The value of the formula (I) is calculated from these values and the content ratio of the dispersing agent is determined.

### Preparation Example 1

### Preparation of Sample No. 101

—Preparation of Added Solution—

The following added solution A, added solution and added solution H were prepared in advance. Here, the added solution G and the added solution H are dispersing agents.

[Preparation of Added Solution A]

After dissolving 0.51 g of silver nitrate powder in 50 mL of pure water and then adding 1N of ammonia water until clear, pure water was added such that the total amount became 100 mL.

[Preparation of Added Solution G]

The added solution G was prepared by dissolving 0.5 g of glucose powder in 140 mL of pure water.

[Preparation of Added Solution H]

The added solution H was prepared by dissolving 0.5 g of HTAB (hexadecyl trimethyl ammonium bromide) powder in 27.5 mL of pure water.

—Preparation of Silver Nanowire Aqueous Dispersion—

410 mL of pure water was added to a three-necked flask and, while stirring at 20° C., 82.5 mL of added solution H and 206 mL of added solution G were added thereto with a funnel (first stage). A total of 206 mL of the added solution A was added dropwise to the obtained liquid at a flow rate of 2.0 mL/min while stirring at 800 rpm (second stage). After the dropwise addition of the added solution A, stirring was performed for 10 minutes and 82.5 mL of the added solution H were further added (third stage). Next, the mixture was heated to an internal temperature of 75° C. at 3° C./min. After that, a silver nanowire aqueous dispersion was obtained by decreasing the rotation speed to 200 rpm, heating for 5 hours, and cooling to room temperature.

—Cleaning Step—

An ultrafiltration module PSP-003 (manufactured by Asahi Kasei Co., Ltd., pore diameter 0.1 μm), a tubing pump, and a stainless steel cup were connected by a tube made of silicone and set as the ultrafiltration apparatus.

500 mL of the silver nanowire aqueous dispersion (containing 81.5 mass % of HTAB as the dispersing agent at the dispersing agent content ratio shown in formula (I) described above) was added to the stainless steel cup of the ultrafiltration apparatus and ultrafiltration was performed by operating the pump. When the circulating fluid became 50 mL, 450 mL of a 0.5 mass % HTAB aqueous solution as a cleaning solution was added to the stainless steel cup, and cleaning was performed. The cleaning described above was repeated for a total of 10 times. After that, 450 mL of distilled water was added to the stainless steel cup, and further cleaning was performed. The sample No. 101 was prepared by repeatedly performing this cleaning step until the content of the dispersing agent became 3.3 mass % at a dispersing agent content ratio shown in formula (I) described above.

The average short axis length (the average diameter) of the silver nanowires in the obtained Sample No. 101, the average long axis length, the suitable metal wire ratio, and the variation coefficient of the short axis lengths of the silver nanowires are shown in Table 1.

### Preparation Example 2

### Preparation of Sample No. 102

Sample No. 102 was prepared in the same manner as preparation example 1 except that the cleaning was performed until the content of the dispersing agent became 3.7 mass % in the cleaning step.

The average short axis length (the average diameter) of the silver nanowires in the obtained Sample No. 102, the average long axis length, the suitable metal wire ratio, and the variation coefficient of the short axis lengths of the silver nanowires are shown in Table 1.

### Preparation Example 3

### Preparation of Sample No. 103

Sample No. 103 was prepared in the same manner as preparation example 1 except that the cleaning was performed until the content of the dispersing agent became 5.0 mass % in the cleaning step.

The average short axis length (the average diameter) of the silver nanowires in the obtained Sample No. 103, the average long axis length, the suitable metal wire ratio, and the variation coefficient of the short axis lengths of the silver nanowires are shown in Table 1.

### Preparation Example 4

### Preparation of Sample No. 104

Sample No. 104 was prepared in the same manner as preparation example 1 except that the cleaning was performed until the content of the dispersing agent became 10.0 mass % in the cleaning step.

The average short axis length (the average diameter) of the silver nanowires in the obtained Sample No. 104, the average long axis length, the suitable metal wire ratio, and the variation coefficient of the short axis lengths of the silver nanowires are shown in Table 1.

### Preparation Example 5

### Preparation of Sample No. 105

Sample No. 105 was prepared in the same manner as preparation example 1 except that the initial temperature during the mixing of the first stage was changed from 20° C. to 30° C.

The average short axis length (the average diameter) of the silver nanowires in the obtained Sample No. 105, the average long axis length, the suitable metal wire ratio, and the variation coefficient of the short axis lengths of the silver nanowires are shown in Table 1.

### Preparation Example 6

### Preparation of Sample No. 106

Sample No. 106 was prepared in the same manner as preparation example 1 except that the HTAB which was added to the added solution H was changed to stearyl trimethyl ammonium bromide (STAB) which was equimolar to the HTAB.

The average short axis length (the average diameter) of the silver nanowires in the obtained Sample No. 106, the average long axis length, the suitable metal wire ratio, and the variation coefficient of the short axis lengths of the silver nanowires are shown in Table 1.

### Preparation Example 7

### Preparation of Sample No. 107

Sample No. 107 was prepared in the same manner as preparation example 1 except that the cleaning was performed until the content of the dispersing agent became 3.2 mass % in the cleaning step.

The average short axis length (the average diameter) of the silver nanowires in the obtained Sample No. 107, the average long axis length, the suitable metal wire ratio, and the variation coefficient of the short axis lengths of the silver nanowires are shown in Table 1.

### Preparation Example 8

### Preparation of Sample No. 108

Sample No. 108 was prepared in the same manner as preparation example 1 except that the ultrafiltration module PSP-003 (manufactured by Asahi Kasei Co., Ltd., pore diameter 0.1 μm) used in the cleaning step was changed to an ultrafiltration module PMP-003 (manufactured by Asahi Kasei Co., Ltd., pore diameter 0.25 μm).

The average short axis length (the average diameter) of the silver nanowires in the obtained Sample No. 108, the average long axis length, the suitable metal wire ratio, and the variation coefficient of the short axis lengths of the silver nanowires are shown in Table 1.

### Preparation Example 9

### Preparation of Sample No. 109

Sample No. 109 was prepared in the same manner as preparation example 1 except that cleaning was performed by adding 0.5 mass % of polyvinyl pyrrolidone (PVP K55, manufactured by Wako Pure Chemical Industries, Ltd.) aqueous solution instead of 0.5 mass % of HTAB aqueous solution as the cleaning solution in the cleaning step, and the ultrafiltration was repeatedly performed until the PVP content ratio became 3.3 mass %. After collecting 20 g of the obtained sample No. 109 and drying the sample on a hot plate for five hours at 120° C., analysis was performed using a differential thermal gravimetric apparatus (TG/DTA200 manufactured by Seiko Instruments Inc.) and it was confirmed that PVP was included in the sample No. 109 without including HTAB.

### Preparation Example 10

### Preparation of Sample No. 110

—Preparation of Silver Nanowire Dispersion—

30 mL of ethylene glycol was added to a three-necked flask and heated to 160° C. After that, 18 mL of the ethylene glycol solution A which was prepared by the method shown below and 18 mL of the ethylene glycol solution B which was prepared by the method shown below were each added dropwise at a flow rate of 1 mL/min with stirring at 400 rpm. Then, a silver nanowire dispersion was obtained by heating the mixture for 60 minutes at 160° C. and then cooling to room temperature.

Below, this method of preparing a silver nanowire dispersion may be referred to as the “polyol method”.

[Preparation of Ethylene Glycol Solution A]

36 mM of polyvinyl pyrrolidone (PVP K55, manufactured by Wako Pure Chemical Industries, Ltd.), 3 μM acetylacetonate iron, and 60 μM sodium chloride were dissolved in ethylene glycol.

[Preparation of Ethylene Glycol Solution B]

24 mM of silver nitrate was dissolved in ethylene glycol.

—Cleaning Step—

An ultrafiltration module PSP-003 (manufactured by Asahi Kasei Co., Ltd., pore diameter 0.1 μm), a tubing pump, and a stainless steel cup were connected by a tube made of silicone and set as the ultrafiltration apparatus.

500 mL of the silver nanowire dispersion was added to the stainless steel cup of the ultrafiltration apparatus and ultrafiltration was performed by operating the pump. When the circulating fluid became 50 mL, 450 mL of 0.5 mass % polyvinyl pyrrolidone (PVP K55 manufactured by Wako Pure Chemical Industries, Ltd.) aqueous solution as a cleaning solution were added to the stainless steel cup, and cleaning was performed. The cleaning described above was repeated for a total of 10 times. After that, 450 mL of distilled water was added to the stainless steel cup, and further cleaning was performed. The sample No. 110 was prepared by repeatedly performing this cleaning step until the content of the dispersing agent became 3.5 mass % at a dispersing agent content ratio shown in formula (I) described above.

The average short axis length (the average diameter) of the silver nanowires in the obtained Sample No. 110, the average long axis length, the suitable metal wire ratio, and the variation coefficient of the short axis lengths of the silver nanowires are shown in Table 1.

### Preparation Example 11

### Preparation of Sample No. 201

Sample No. 201 was prepared in the same manner as preparation example 1 except that the cleaning was performed until the content of the dispersing agent became 2.8 mass % in the cleaning step.

The average short axis length (the average diameter) of the silver nanowires in the obtained Sample No. 201, the average long axis length, the suitable metal wire ratio, and the variation coefficient of the short axis lengths of the silver nanowires are shown in Table 1.

### Preparation Example 12

### Preparation of Sample No. 202

Sample No. 202 was prepared in the same manner as preparation example 1 except that the cleaning was performed until the content of the dispersing agent became 1.5 mass % in the cleaning step.

The average short axis length (the average diameter) of the silver nanowires in the obtained Sample No. 202, the average long axis length, the suitable metal wire ratio, and the variation coefficient of the short axis lengths of the silver nanowires are shown in Table 1.

### Preparation Example 13

### Preparation of Sample No. 203

Sample No. 203 was prepared in the same manner as preparation example 1 except that the cleaning was performed until the content of the dispersing agent became 3.1 mass % in the cleaning step.

The average short axis length (the average diameter) of the silver nanowires in the obtained Sample No. 203, the average long axis length, the suitable metal wire ratio, and the variation coefficient of the short axis lengths of the silver nanowires are shown in Table 1.

### Preparation Example 14

### Preparation of Sample No. 204

Sample No. 204 was prepared in the same manner as preparation example 1 except that the cleaning was performed until the content of the dispersing agent became 1.4 mass % in the cleaning step and the ultrafiltration module PSP-003 (manufactured by Asahi Kasei Co., Ltd., pore diameter 0.1 μm) was changed to an ultrafiltration module PMP-003 (manufactured by Asahi Kasei Co., Ltd., pore diameter 0.25 μm).

The average short axis length (the average diameter) of the silver nanowires in the obtained Sample No. 204, the average long axis length, the suitable metal wire ratio, and the variation coefficient of the short axis lengths of the silver nanowires are shown in Table 1.

### Preparation Example 15

### Preparation of Sample No. 205

Sample No. 205 was prepared in the same manner as preparation example 10 except that the cleaning was performed until the content of the dispersing agent became 1.5 mass % in the cleaning step.

The average short axis length (the average diameter) of the silver nanowires in the obtained Sample No. 205, the average long axis length, the suitable metal wire ratio, and the variation coefficient of the short axis lengths of the silver nanowires are shown in Table 1.

TABLE 1

| | Metal Nanowire Dispersion | | | | | | | | | |
|---|---|---|---|---|---|---|---|---|---|---|
| | Metal Nanowire | | | | | | Cleaning Step | | | |
| | | | | | Variation | | | Fractional | | Content of |
| | | | | Suitable | coefficient | | | molecular | | dispersing |
| | | Average | Average | metal | of | | | weight of | | agent after |
| | | short axis | long axis | nanowire | nanowire | | | ultra- | | cleaning |
| Sample | Manufacturing | length | length | ratio | diameter | Dispersing | Cleaning | filtration | Cleaning | step |
| No. | Method | (nm) | (μm) | (mass %) | (%) | Agent | method | film | Solution | (mass %) |
| 101 | Aqueous HTAB | 17.6 | 36.7 | 82.6 | 18.3 | HTAB | Ultrafiltration | 0.1 μm | Dispersing | 3.3 |
| | method | | | | | | | | agent-containing | |
| | | | | | | | | | liquid | |
| 102 | Aqueous HTAB | 17.6 | 36.7 | 82.6 | 18.3 | HTAB | Ultrafiltration | 0.1 μm | Dispersing | 3.7 |
| | method | | | | | | | | agent-containing | |
| | | | | | | | | | liquid | |
| 103 | Aqueous HTAB | 17.6 | 36.7 | 82.6 | 18.3 | HTAB | Ultrafiltration | 0.1 μm | Dispersing | 5.0 |
| | method | | | | | | | | agent-containing | |
| | | | | | | | | | liquid | |
| 104 | Aqueous HTAB | 17.6 | 36.7 | 82.6 | 18.3 | HTAB | Ultrafiltration | 0.1 μm | Dispersing | 10.0 |
| | method | | | | | | | | agent-containing | |
| | | | | | | | | | liquid | |
| 105 | Aqueous HTAB | 48.3 | 32.3 | 62.7 | 33.4 | HTAB | Ultrafiltration | 0.1 μm | Dispersing | 3.3 |
| | method | | | | | | | | agent-containing | |
| | | | | | | | | | liquid | |
| 106 | Aqueous STAB | 18.6 | 25.3 | 88.3 | 16.2 | STAB | Ultrafiltration | 0.1 μm | Dispersing | 3.3 |
| | method | | | | | | | | agent-containing | |
| | | | | | | | | | liquid | |
| 107 | Aqueous HTAB | 17.6 | 36.7 | 82.6 | 18.3 | HTAB | Ultrafiltration | 0.1 μm | Dispersing | 3.2 |
| | method | | | | | | | | agent-containing | |
| | | | | | | | | | liquid | |
| 108 | Aqueous HTAB | 17.6 | 36.7 | 82.6 | 18.3 | HTAB | Ultrafiltration | 0.25 μm | Dispersing | 3.3 |
| | method | | | | | | | | agent-containing | |
| | | | | | | | | | liquid | |
| 109 | Aqueous PVP | 17.6 | 36.7 | 82.6 | 18.3 | PVP | Ultrafiltration | 0.1 μm | Dispersing | 3.3 |
| | method | | | | | | | | agent-containing | |
| | | | | | | | | | liquid | |
| 110 | Polyol method | 75 | 10 | 64.2 | 32.7 | PVP | Ultrafiltration | 0.1 μm | Dispersing | 3.5 |
| | | | | | | | | | agent-containing | |
| | | | | | | | | | liquid | |
| 201 | Aqueous HTAB | 17.6 | 36.7 | 82.6 | 18.3 | HTAB | Ultrafiltration | 0.1 μm | Dispersing | 2.8 |
| | method | | | | | | | | agent-containing | |
| | | | | | | | | | liquid | |
| 202 | Aqueous HTAB | 17.6 | 36.7 | 82.6 | 18.3 | HTAB | Ultrafiltration | 0.1 μm | Dispersing | 1.5 |
| | method | | | | | | | | agent-containing | |
| | | | | | | | | | liquid | |
| 203 | Aqueous HTAB | 17.6 | 36.7 | 82.6 | 18.3 | HTAB | Ultrafiltration | 0.1 μm | Dispersing | 3.1 |
| | method | | | | | | | | agent-containing | |
| | | | | | | | | | liquid | |
| 204 | Aqueous HTAB | 17.6 | 36.7 | 82.6 | 18.3 | HTAB | Ultrafiltration | 0.25 μm | Distilled water | 1.4 |
| | method | | | | | | | | | |
| 205 | Polyol method | 75 | 10 | 64.2 | 32.7 | PVP | Ultrafiltration | 0.1 μm | Dispersing | 1.5 |
| | | | | | | | | | agent-containing | |
| | | | | | | | | | liquid | |

### Examples 1 to 10 and Comparative Examples 1 to 5

### Preparation of Undercoat Layer

A corona discharge treatment of 8 W/m² per minute was performed on a commercially available polyethylene terephthalate (PET) substrate with a thickness of 100 μm which was biaxially oriented and heat fixed in advance and then an undercoat layer with the following composition was coated thereon such that the thickness after drying was 0.8 μm.

[Composition of Undercoat Layer]

The composition of the undercoat layer contains a copolymer latex of butyl acrylate (40 mass %), styrene (20 mass %), and glycidyl acrylate (40 mass %), and hexamethylene-1,6-bis(ethylene urea), and the content of the hexamethylene-1,6-bis(ethylene urea) is 0.5 mass %.

### Preparation of Hydrophilic Polymer Layer

The surface of the undercoat layer was subjected to a corona discharge treatment of 8 W/m² per minute and then hydroxyethyl cellulose was coated thereon as a hydrophilic polymer layer such that the thickness after drying was 0.2 μm.

### Preparation of Conductive Film

Sample Nos. 101 to 110 and 201 to 205 were coated onto the hydrophilic polymer layer using a PI-1210 automatic coating apparatus (manufactured by Tester Sangyo Co., Ltd.) and dried to obtain the conductive films of Examples 1 to 10 and Comparative Examples 1 to 5.

### Evaluation

Next, for each of the obtained conductive films, the conductivity, transparency, haze, and pimple defects were evaluated with the following methods. The results are shown in Table 2.

### Evaluation of Conductivity

The surface resistance of the conductive films of the Examples and Comparative Examples was measured using a surface resistance meter (Loresta-GP MCP-T600 manufactured by Mitsubishi Chemical Corporation), and the conductivity was evaluated based on the following evaluation criteria. A lower surface resistance value means a higher conductivity.

[Evaluation Criteria]

A: Surface resistance is less than 100 Ω/sq, which is a level with no problems during practical use.

B: Surface resistance is 100 Ω/sq or more and less than 500 Ω/sq, which is a level with no problems during practical use.

C: Surface resistance is 500 Ω/sq or more and less than 1,000 Ω/sq, which is a level with no problems during practical use.

D: Surface resistance is 1,000 Ω/sq or more, which is a level with problems during practical use.

### Evaluation of Transparency

The total light transmittance of the conductive films of the Examples and Comparative Examples was measured using an integrating sphere light transmittance measuring apparatus (Haze-Gard Plus, manufactured by Gardner Co., Ltd.), and the transparency was evaluated based on the following evaluation criteria.

[Evaluation Criteria]

A: Total light transmittance is 90% or more, which is a level with no problems during practical use.

B: Total light transmittance is 80% or more and less than 90%, which is a level with no problems during practical use.

C: Total light transmittance is 75% or more and less than 80%, which is a level with no problems during practical use.

D: Total light transmittance is 0% or more and less than 75%, which is a level with problems during practical use.

### Evaluation of Haze

The haze of the conductive films of the Examples and Comparative Examples was measured using an integrating sphere light transmittance measuring apparatus (Haze-Gard Plus, manufactured by Gardner Co., Ltd.), and the haze was evaluated based on the following evaluation criteria.

[Evaluation Criteria]

A: Haze is less than 1.5%, which is a level with no problems during practical use.

B: Haze is 1.5% or more and less than 2.0%, which is a level with no problems during practical use.

C: Haze is 2.0% or more and less than 3%, which is a level with no problems during practical use.

D: Haze is 3% or more, which is a level with problems during practical use.

### Evaluation of Pimple Defects

The numbers of pimple defects caused by the silver nanowires inside 5 cm square central portions of the conductive films of the Examples and Comparative Examples were observed with an optical microscope and the pimple defects were evaluated based on the following evaluation criteria.

[Evaluation Criteria]

A: Number of pimple defects is 2 or less in the 5 cm square.

B: Number of pimple defects is 3 or more and 5 or less in the 5 cm square.

C: Number of pimple defects is 6 or more and 10 or less in the 5 cm square.

D: Number of pimple defects is 11 or more and 20 or less in the 5 cm square.

E: Number of pimple defects is 21 or more in the 5 cm square.

TABLE 2

| | Sample | | | | Pimple |
|---|---|---|---|---|---|
| | No. | Conductivity | Transparency | Haze | Defects |
| Example 1 | 101 | A | A | A | A |
| Example 2 | 102 | A | A | A | A |
| Example 3 | 103 | B | A | A | A |
| Example 4 | 104 | B | B | A | A |
| Example 5 | 105 | A | A | B | B |
| Example 6 | 106 | A | A | A | A |
| Example 7 | 107 | A | A | A | B |
| Example 8 | 108 | A | A | A | A |
| Example 9 | 109 | A | A | A | A |
| Example 10 | 110 | B | A | C | B |
| Comparative | 201 | B | A | A | D |
| Example 1 | | | | | |
| Comparative | 202 | B | A | B | E |
| Example 2 | | | | | |
| Comparative | 203 | A | A | A | D |
| Example 3 | | | | | |
| Comparative | 204 | C | B | B | E |
| Example 4 | | | | | |
| Comparative | 205 | C | B | D | E |
| Example 5 | | | | | |

### Example 11

Touch panels were manufactured using the conductive film of Example 1 according to the methods described in “Latest Touch Panel Technology” (issued Jul. 6, 2009, Techno Times), supervised by Yuji Mitani, “Technology and Development of Touch Panels”, CMC Publishing (issued December 2004), “FPD International 2009 Forum T-11 Lecture Text Book”, “Cypress Semiconductor Corporation Application Note AN2292,” or the like.

It was found that, when the manufactured touch panels are used, it is possible to manufacture touch panels where the visibility was excellent due to the improvement in the transmittance and the responsiveness was excellent when inputting characters or the like or performing screen operations using at least one out of bare hands, hands wearing gloves, or pointing tools due to the improvement in the conductivity.

Since it is possible for the method for manufacturing a conductive film of the present invention to manufacture a conductive film which has low hazing, few pimple defects, and excellent conductivity and transparency, where favorable dispersion is possible without the metal nanowires being aggregated during coating, it is possible for the conductive film which is manufactured according to the method for manufacturing a conductive film to be widely used in for example, touch panels, display electrodes, electromagnetic shielding, organic or inorganic El display electrodes, E-paper, flexible display electrodes, integrated solar cells, display elements, various other types of device, and the like.

The present application is a continuation application of International Application No. PCT/JP2012/066219, filed Jun. 26, 2012, which claims priority to Japanese Patent Application No. 2011-146061, filed Jun. 30, 2011. The contents of these applications are incorporated herein by reference in their entirety.

What is claimed is:

1. A method for manufacturing a conductive film comprising:
cleaning a metal nanowire dispersion, which contains metal nanowires with an average short axis length of 150 nm or less as metal particles and a dispersing agent, by performing ultrafiltration using an ultrafiltration film; and
coating a coating liquid for forming a conductive film, which contains the metal nanowire dispersion after cleaning, onto a support,
wherein the content ({mass of the dispersing agent/(mass of all metal particles+mass of the dispersing agent)}×100) of the dispersing agent in the metal nanowire dispersion after cleaning is 3.2 mass % or more.

2. The method for manufacturing a conductive film according to claim 1, wherein the content of the dispersing agent is 3.2 mass % or more and 20 mass % or less.

3. The method for manufacturing a conductive film according to claim 1, wherein the content of the dispersing agent is 3.2 mass % or more and 5 mass % or less.

4. The method for manufacturing a conductive film according to claim 1, wherein the metal nanowires are formed by heating an aqueous solution which contains a metallic complex to a temperature which is the boiling point or less of the aqueous solution to reduce the metallic complex.

5. The method for manufacturing a conductive film according to claim 1, wherein the dispersing agent is at least one selected from a group consisting of polyvinyl pyrrolidone, hexadecyl trimethyl ammonium bromide, hexadecyl trimethyl ammonium chloride, and stearyl trimethyl ammonium bromide.

6. The method for manufacturing a conductive film according to claim 1, wherein the pore diameter of the ultrafiltration film is 1 μm or less.

7. The method for manufacturing a conductive film according to claim 1, wherein a cleaning fluid used during the ultrafiltration is a solution which includes a dispersing agent.

8. The method for manufacturing a conductive film according to claim 1, which does not include a dispersing step of dispersing the metal nanowire in the presence of the dispersing agent using a disperser.

9. The method for manufacturing a conductive film according to claim 1, wherein the metal nanowires of which the average short axis length is 50 nm or less and the average long axis length is 5 μm or more are included as 50 mass % or more of the metal amount in all the metal particles.

10. The method for manufacturing a conductive film according to claim 1, wherein the metal nanowires contain silver.

11. A conductive film which is manufactured using the method for manufacturing a conductive film according to claim 1.

12. A touch panel comprising the conductive film according to claim 11.

13. A method for manufacturing a metal nanowire dispersion comprising:
a cleaning step of performing ultrafiltration using an ultrafiltration film on a metal nanowire dispersion, which contains metal nanowires with an average short axis length of 150 nm or less as metal particles and a dispersing agent, and cleaning the metal nanowire dispersion,
wherein the content ({mass of the dispersing agent/(mass of all metal particles+mass of the dispersing agent)}×100) of the dispersing agent in the metal nanowire dispersion after cleaning is 3.2 mass % or more.
